(19) United States
(12) Patent Application Publication
(10) Pub. No.: US 2026/0358629 A1
(43) Pub. Date: Nov. 12, 2026

(54) TWO-DIMENSIONAL ARRAY OPTICAL WAVEGUIDE OF EYEBOX EXPANSION SCHEME FOR LIGHT GUIDE PIPE

(71) Applicant: Optowide Technologies Co., Ltd., Fuzhou City (CN)

(72) Inventors: Qifeng YANG, Fuzhou City (CN); Qiping Wang, Fuzhou City (CN); Jie Hong, Fuzhou City (CN); Qianqian Hu, Fuzhou City (CN); Zhihui He, Fuzhou City (CN)

(21) Appl. No.: 19/266,368

(22) Filed: Jul. 11, 2025

(30) Foreign Application Priority Data
May 8, 2025 (CN) 202510591667.1

(51) Int. Cl. G02B 27/01

(52) U.S. Cl. CPC G02B 27/0101; G02B 2027/0123

(57) ABSTRACT

A two-dimensional array optical waveguide of an eyebox expansion scheme for a light guide pipe is provided. The.The present disclosure discloses, including: a coupling-in module, an eyebox expansion array module, and a coupling-out array module, where the coupling-in module, the eyebox expansion array module, and the coupling-out array module are in optical contact pairwise; the coupling-in module and the coupling-out array module are located on left and right sides of the eyebox expansion array module, respectively.

### CROSS-REFERENCE TO RELATED APPLICATION

This application claims priority to Chinese Patent Application No. 202510591667.1, filed on May 8, 2025, the contents of which are hereby incorporated by reference.

### TECHNICAL FIELD

The present disclosure belongs to the technical field of optical display and integrated photonics, and in particular relates to a two-dimensional array optical waveguide of an eyebox expansion scheme for a light guide pipe.

### BACKGROUND

Array optical waveguide displays may be used in augmented reality (AR) devices to provide a more realistic visual experience. Current array optical waveguide solutions are mainly divided into two categories: one-dimensional array optical waveguides and two-dimensional array optical waveguides. Among them, one-dimensional array optical waveguides have gradually matured in recent years, and many manufacturers have begun mass-producing related products. However, the optical engine part of such products is bulky, negatively impacting the user experience.

The optical engine part of two-dimensional array optical waveguides is relatively lightweight, making them the optimal choice for future C-end consumers. However, the current production yield of two-dimensional array optical waveguides is extremely low, and the cost of mass-producing high-quality imaging two-dimensional array optical waveguides is high. Their designs generally suffer from the following pain points.

### High-Cost Issues:

In traditional two-dimensional array optical waveguides, eyebox expansion typically relies on a cascaded structure of multilayer partial reflectors, as shown in FIG. 1. Some designs that fully consider the imaging grid sensing requirements require 20-40 partial reflectors to achieve relatively uniform energy distribution for rays at various angles within the field of view (FOV), with slight waveguide grid sensing. The processing cost of the substrates is significantly higher compared to one-dimensional array optical waveguides.

Due to the large number of partial reflectors required for eyebox expansion, the labor cost for optical contact increases substantially. The difference in surface type of thin film optical contact gradually accumulates with the number of optical contact, requiring more layers of optical contact and longer processing times.

Due to the large number of partial reflectors required for eyebox expansion, errors accumulated during processing significantly reduce yield, such as lens wear, film cracking, and demolding during deep optical contact.

### Low-Quality Issues:

In traditional two-dimensional array optical waveguides, eyebox expansion typically relies on a cascaded structure of multilayer partial reflectors. The intervals between these partial reflectors are usually uniform or limited to one or two sizes, making it impossible to achieve uniform energy distribution for all angles within the FOV. The energy difference between light incident on the pupil at various angles remains constant. While appropriate design may reduce grid sensing in traditional two-dimensional array optical waveguides, the cost increases and the yield decreases accordingly. Therefore, a traditional two-dimensional array optical waveguide that comprehensively considers production cost and imaging effect typically exhibit stronger grid sensing than a one-dimensional array optical waveguide, negatively impacting user comfort.

In traditional two-dimensional array optical waveguides, eyebox expansion typically relies on multilayer partial reflectors. Due to accumulation of various substrate surface types, optical contact becomes increasingly difficult for later substrates, often requiring multiple manual repairs or ion beam etching to activate surfaces. As a result, the final layer material of the partial reflectors is damaged, and the spectral performance of the originally coated energy partial reflector with good flatness decreases. The good white balance of the product is difficult to achieve, and the larger the FOV, the worse the color uniformity within the image.

In traditional two-dimensional array optical waveguides, eyebox expansion typically relies on multilayer partial reflectors, so the reflectivity of each partial reflector is relatively low. The ripple of the spectrum of the partial reflector has a greater impact on white balance, making it difficult to achieve good product white balance.

### SUMMARY

To solve the problems of high substrate cost, complex coating process and poor reliability of optical contact caused by the traditional two-dimensional optical waveguide eyebox expansion technology relying on high-density partial reflectors (20-40 layers), the present disclosure provides a two-dimensional array optical waveguide of an eyebox expansion scheme for a light guide pipe, including:
a coupling-in module, an eyebox expansion array module, and a coupling-out array module;
where the coupling-in module, the eyebox expansion array module, and the coupling-out array module are in optical contact pairwise;
the coupling-in module and the coupling-out array module are located on left and right sides of the eyebox expansion array module, respectively;
the coupling-in module is used to introduce rays outgoing from a two-dimensional optical engine into an optical waveguide system and adjust an angle and a direction of the rays through reflection films to meet a total internal reflection condition for entering the eyebox expansion array module;
the eyebox expansion array module is used for eyebox expansion of coupled-in rays, enabling uniform distribution of the rays within the optical waveguide; and
the coupling-out array module is used to efficiently couple rays after the eyebox expansion out of the optical waveguide to obtain a target image.

Optionally, the coupling-in module includes a rectangular prism with a total internal reflection film and the reflection films;
the reflection films are coated on oblique edges of the rectangular prism, and are tilted 25.7 degrees (°) and bonded in H-ZF1A glass; and
a working wavelength of the reflection films is visible light.

Optionally, the rectangular prism with the internal total internal reflection film includes two right trapezoidal prisms;
an oblique edge angle of the right trapezoidal prisms is 25.7°, and the oblique edges of the two right trapezoidal prisms are bonded together;
a mechanical angle of the reflection films is 25.7°; and
an incident angle of the reflection films 9 is 25.7°±15°.

Optionally, the eyebox expansion array module includes a light guide pipe and trapezoidal prisms;
the light guide pipe is a parallelepiped, with front and rear surfaces serving as surfaces for total internal reflection and oscillation of rays with a pitch direction as a reference; and
the light guide pipe is coated with the total internal reflection film and an energy partial reflector to perform the eyebox expansion of the coupled-in rays.

Optionally, an upper surface of the light guide pipe is a light guide pipe energy partial reflector, and an angle between the light guide pipe energy partial reflector and the front and rear surfaces is 90°, and the light guide pipe energy partial reflector is in optical contact with an oblique surface of one of the trapezoidal prisms;
a lower surface of the light guide pipe is a light guide pipe total internal reflection film, and an angle between the light guide pipe total internal reflection film and the front and rear surfaces is 90°, the light guide pipe total internal reflection film is parallel to the light guide pipe energy partial reflector, and the light guide pipe total internal reflection film is in optical contact with an oblique surface of one of the trapezoidal prisms;
a left surface of the light guide pipe is a ray coupling-in surface, and the ray coupling-in surface forms a 90° angle with the front and rear surfaces and a 45° angle with the light guide pipe energy partial reflector and the light guide pipe total internal reflection film;
a right surface of the light guide pipe is a ray coupling-out surface, and the ray coupling-out surface forms a 90° angle with the front and rear surfaces and a 45° angle with the light guide pipe energy partial reflector and the light guide pipe total internal reflection film.

Optionally, the light guide pipe total internal reflection film is incident at a visible light wavelength and an incident angle of 56.5°±15°; and
the light guide pipe energy partial reflector is incident at the visible light wavelength and the incident angle of 56.5°±15°.

Optionally, a tilt angle of the light guide pipe is related to required field of view (FOV), eyebox, and eye relief of a product; and
the larger the eyebox, the greater the tilt angle of the light guide pipe.

Optionally, the coupling-out array module includes parallelepipeds and trapezoidal prisms;
upper and lower surfaces of the coupling-out array module are coated with anti-reflection films;
inclined surfaces of the parallelepipeds are coated with coupling-out energy partial reflectors; and
an angle between the coupling-out energy partial reflectors and the upper and lower surfaces is 25.7°, a first surface and a last surface are respectively in optical contact with one of the trapezoidal prisms, and the parallelepipeds are in optical contact pairwise.

Optionally, a mechanical angle of the coupling-out energy partial reflectors is 25.7°;
the mechanical angle of the coupling-out energy partial reflectors is equal to a mechanical angle of a coupling-in reflection film; and
a number of layers of the coupling-out energy partial reflectors is related to required FOV, eyebox, eye relief, and waveguide thickness, with energy increasing progressively along a ray transmission direction.

Optionally, both surfaces of the array optical waveguide are coated with anti-reflection films for visible light against air.

Compared with the prior art, the present disclosure has the following advantages and technical effects.

The design of the eyebox expansion part in the present disclosure is simple, significantly reducing processing difficulty while greatly improving imaging quality. Its excellent optical characteristics, cost-effectiveness, and shortened processing cycle will promote the development of the two-dimensional array optical waveguide industry in the market.

### BRIEF DESCRIPTION OF THE DRAWINGS

The drawings, which form a part of the present disclosure, are intended to provide a further understanding of the present disclosure. The schematic embodiments and descriptions of the present disclosure are intended to explain the present disclosure and do not constitute an undue limitation of the present disclosure. In the drawings:

FIG. 1 is a schematic diagram of the design scheme of the traditional two-dimensional optical waveguide in the background of the present disclosure.

FIG. 2 is a schematic diagram of the design scheme of the two-dimensional optical waveguide in the embodiment of the present disclosure.

FIG. 3 is a schematic diagram of the structure of the internal reflection films and energy partial reflectors in the design scheme of the two-dimensional optical waveguide in the embodiment of the present disclosure.

FIG. 4 is a schematic diagram of ray transmission in the coupling-out scheme of the two-dimensional optical waveguide in the embodiment of the present disclosure.

FIG. 5 is a schematic diagram of ray transmission in the eyebox expansion scheme of the two-dimensional optical waveguide in the embodiment of the present disclosure.

FIG. 6 is a simulation diagram of the variation of the coating reflectivity of the light guide pipe energy partial reflector with the incident angle in the two-dimensional optical waveguide scheme of the embodiment of the present disclosure.

FIG. 7 is a schematic diagram of the light guide pipe in the two-dimensional optical waveguide scheme of the embodiment of the present disclosure.

FIG. 8 is a schematic diagram of the coupling-out array module in the two-dimensional optical waveguide scheme of the embodiment of the present disclosure.

### DETAILED DESCRIPTION OF THE EMBODIMENTS

It should be noted that, in the absence of conflict, the embodiments and features of the embodiments in the present disclosure may be combined with each other. The present disclosure will be described in detail below with reference to the drawings and embodiments.

It should be noted that the steps illustrated in the flowchart of the drawings may be executed in a computer system, such as a set of computer-executable instructions. Moreover, although the flowchart shows a logical order, in some cases, the steps may be executed in an order different from the one shown or described herein.

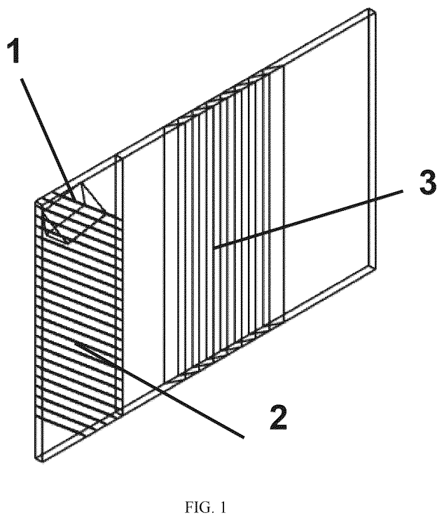

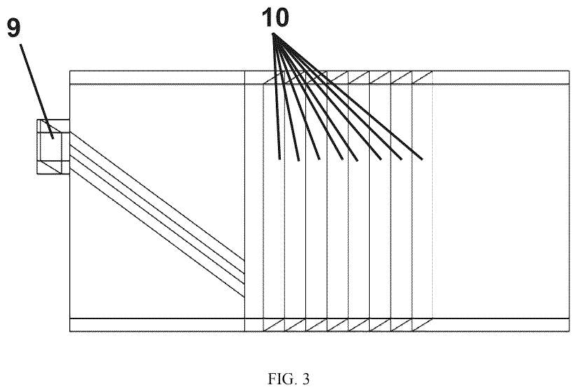

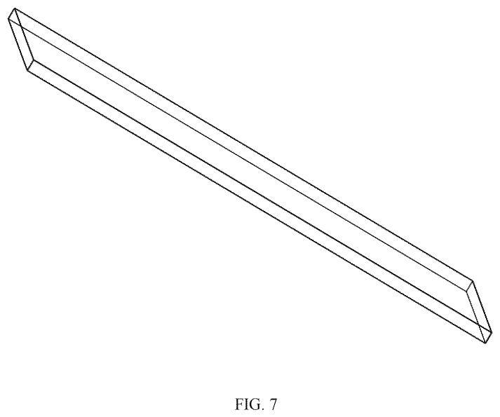

As shown in FIG. 1-FIG. 8, this embodiment provides a two-dimensional array optical waveguide of an eyebox expansion scheme for a light guide pipe, including: a coupling-in module, an eyebox expansion array module, and a coupling-out array module.

The coupling-in module, the eyebox expansion array module, and the coupling-out array module are in optical contact pairwise.

The coupling-in module is used to introduce rays outgoing from a two-dimensional optical engine into an optical waveguide system and adjust the angle and direction of the rays through reflection films to meet the total internal reflection condition for entering the eyebox expansion array module.

The eyebox expansion array module is used for eyebox expansion of coupled-in rays, enabling uniform distribution of the rays within the optical waveguide.

The coupling-out array module is used to efficiently couple the rays after eyebox expansion out of the optical waveguide to obtain a target image.

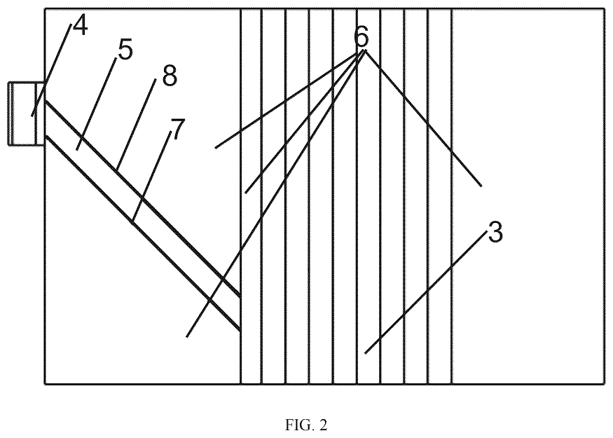

As shown in FIG. 2, in terms of spatial position, the coupling-in module and the coupling-out array module are located on the left and right sides of the eyebox expansion array module, respectively. This embodiment is the left-eye augmented reality (AR) solution, with the coupling-in module located on the left side of the eyebox expansion array module and the coupling-out array module on the right side of the eyebox expansion array module.

In an embodiment, the coupling-in module consists of two right trapezoidal prisms, with an oblique edge angle of the prisms being 25.7 degrees (°). The reflection films are coated on the oblique edges of the prisms. The oblique edges of the two right trapezoidal prisms are bonded together to form a rectangular coupling-in module.

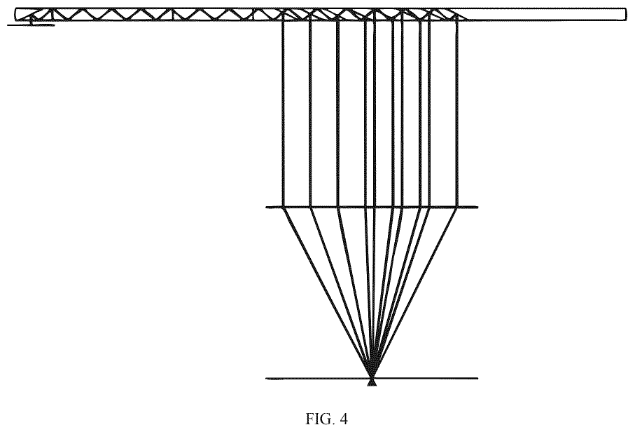

In an embodiment, the chief ray outgoing from the two-dimensional optical engine is perpendicular to the coupling-in module. The reflection films 9 of the coupling-in module are tilted 25.7° and bonded in H-ZF1A glass, exhibiting high reflectivity for rays with visible light wavelengths and incident angles of 25.7°±15°. The chief ray from the two-dimensional optical engine is incident on the surfaces of the reflection films 9 at 25.7°, and after reflection, the total internal reflection angle of the optical waveguide is satisfied, so the rays are transmitted within the array optical waveguide in an oscillating manner, as shown in FIG. 4.

As an additional implementation, the coupling-in module is a rectangular prism with a total internal reflection film, i.e., an array optical waveguide coupling-in prism 1. An array optical waveguide coupling-in reflection film module 4 includes multiple reflection films 9. The mechanical angle of the reflection films 9 is preferably 25.7°, the working wavelength of the reflection films 9 is visible light, and the incident angle of the reflection films 9 is 25.7°±15°.

In an embodiment, the eyebox expansion array module is a Z-LENS array optical waveguide eyebox expansion structure 2, consisting of a light guide pipe 5 and trapezoidal prisms 6.

The light guide pipe 5 is a parallelepiped, with the front and rear surfaces serving as surfaces for total internal reflection and oscillation of rays with the pitch direction in FIG. 2 as the reference.

The upper surface of the light guide pipe 5 is a light guide pipe energy partial reflector 8, and the angle between the light guide pipe energy partial reflector 8 and the front and rear surfaces is 90°, and the light guide pipe energy partial reflector 8 is in optical contact with an oblique surface of one of the trapezoidal prisms 6.

The lower surface of the light guide pipe 5 is a light guide pipe total internal reflection film 7, and the angle between the light guide pipe total internal reflection film 7 and the front and rear surfaces is 90°, the light guide pipe total internal reflection film 7 is parallel to the light guide pipe energy partial reflector 8, and the light guide pipe total internal reflection film 7 is in optical contact with an oblique surface of one of the trapezoidal prisms 6.

The left surface of the light guide pipe 5 is a ray coupling-in surface, and the ray coupling-in surface forms a 90° angle with the front and rear surfaces and a 45° angle with the light guide pipe energy partial reflector 8 and the light guide pipe total internal reflection film 7.

The right surface of the light guide pipe 5 is a ray coupling-out surface, and the ray coupling-out surface forms a 90° angle with the front and rear surfaces and a 45° angle with the light guide pipe energy partial reflector 8 and the light guide pipe total internal reflection film 7.

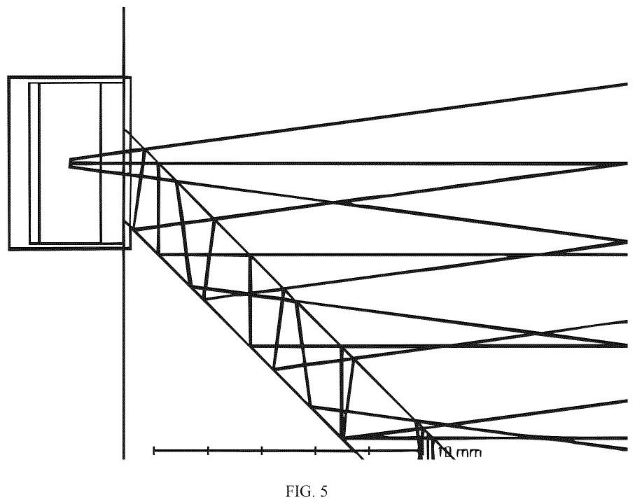

In an embodiment, the eyebox expansion array module is an eyebox expansion part composed of the light guide pipe 5 and two trapezoidal prisms 6 in optical contact. The light guide pipe 5 is coated with the light guide pipe total internal reflection film 7 and the light guide pipe energy partial reflector 8 to perform eyebox expansion of the coupled-in rays. The rays are and transmitted back and forth inside the oblique incident light guide pipe in an oscillating manner, and the schematic diagram of ray transmission is shown in FIG. 5. The light guide pipe energy partial reflector 8 controls the reflectivity, overflow energy, and uniform energy distribution for all angles. The reflectivity requirement of each angle is related to the transmission times of rays in this direction in the light guide pipe.

The rays transmitted from the coupling-in module overflows part of the energy and reflects part of the energy in the light guide pipe 5 of the eyebox expansion array module through the light guide pipe energy partial reflector 8. The reflected part of the energy passes through the light guide pipe total internal reflection film 7 and is totally reflected back to the light guide pipe energy partial reflector 8. Each transmission on the light guide pipe energy partial reflector 8 overflows energy to achieve the eyebox expansion effect, as shown in FIG. 5.

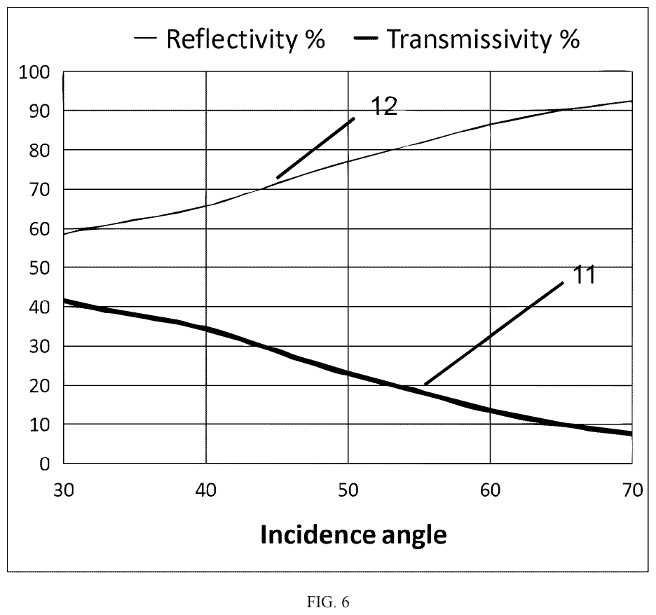

In an embodiment, as shown in FIG. 6, the transmittance variation of energy partial reflector with angle 11 and the reflectance variation of energy partial reflector with angle 12 indicate that the light guide pipe total internal reflection film 7 of the light guide pipe 5 is incident at the visible light wavelength and the incident angle of 56.5°±15°, requiring an extremely high reflection efficiency.

In an embodiment, as shown in FIG. 6, the transmittance variation of energy partial reflector with angle 11 and the reflectance variation of energy partial reflector with angle 12 indicate that the light guide pipe energy partial reflector 8 of the light guide pipe 5 is incident at the visible light wavelength and the incident angle of 56.5°±15°, requiring different reflectivity requirements for different angles.

In an embodiment, the tilt angle of the oblique incident light guide pipe is related to the field of view (FOV), eyebox, and eye relief required by the product. Generally, the larger the required eyebox, the greater the tilt angle of the oblique incident light guide pipe.

In this embodiment, taking eye relief=18 millimeters (mm), eyebox=10*9 mm, FOV=30°, waveguide thickness of 1.2 mm, and the exit pupil of the optical machine of 3.5 mm as an example, the effective overflow of rays transmitted to the large FOV in the eyebox in the light guide pipe 5 is the first two times, the effective overflow of rays transmitted to the intermediate FOV in the eyebox in the light guide pipe 5 is the third and fourth times, the effective overflow of rays transmitted to the small FOV in the eyebox in the light guide pipe 5 is the fifth and sixth times. The design of the light guide pipe energy partial reflector 8 considers that the energy of different FOVs in the eyebox is relatively uniform, so that the transmission energy of the light guide pipe energy partial reflector 8 to the large FOV is x, the transmission energy of the light guide pipe energy partial reflector 8 to the intermediate FOV is y, and the transmission energy of the light guide pipe energy partial reflector 8 to the small FOV is z. Considering that the human eye is insensitive to energy variations within 20%, the energy distribution of the light guide pipe energy partial reflector 8 needs to satisfy the following inequalities:

$$\{ \begin{matrix}x + ( 1 - x ) x = {( 1 - y )}^{2} y + {( 1 - y )}^{3} y = {( 1 - z )}^{4} z + {( 1 - z )}^{5} z \\ ( 1 - x ) > 0.8 \\ ( 1 - y ) > 0.8 \\ ( 1 - z ) > 0.8\end{matrix}$$

The relationship between the thickness of the light guide pipe 5 and the size of the exit pupil of the optical engine is as follows:

$$Thickness of light guide pipe 5 = \frac{Entrance pupil diameter of optical engine}{\sqrt{2}}$$

The above relationship is only applicable to this case, and may be adapted for various designs by adjusting the equation conditions according to design changes.

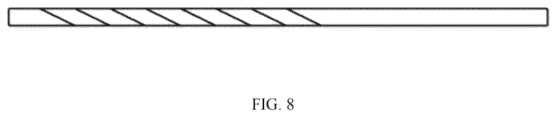

In an embodiment, the coupling-out array module is an array optical waveguide coupling-out structure 3, which is composed of multiple parallelepipeds and two trapezoidal prisms 6, as shown in FIG. 8. With reference to FIG. 8, the upper and lower surfaces are coated with anti-reflection films, and the inclined surfaces of the parallelepipeds are coated with coupling-out energy partial reflectors 10. The angle between the coupling-out energy partial reflectors 10 and the upper and lower surfaces is 25.7°. The first surface and the last surface are respectively in optical contact with one of the trapezoidal prisms 6, and multiple parallelepipeds are in optical contact pairwise to form a parallel flat plate. These results are combined to form a coupling-out array module.

In an embodiment, the mechanical angle of the coupling-out energy partial reflectors 10 is 25.7°. The rays transmitted to the coupling-out array module do not satisfy the total internal reflection angle inside the glass after being reflected by the energy partial reflectors and overflow the waveguide, as shown in FIG. 4.

In an embodiment, the mechanical angle of the coupling-out energy partial reflectors 10 in the coupling-out part is equal to the mechanical angle of the coupling-in reflection film. The number of layers of the energy partial reflector is related to the required FOV, eyebox, eye relief, and waveguide thickness, with energy increasing progressively along the ray transmission direction.

In an embodiment, the number of coupling-out energy partial reflectors 10 in the coupling-out array module is related to the required FOV, eyebox, eye relief, waveguide thickness d, and mechanical angle θ of the coupling-out energy partial reflectors. The number of coupling-out energy partial reflectors 10 and their relationship are represented by the following equation:

$$Number of energy - splitting films = even ( \frac{Heyebox + 2 * eyerilef * tan ( \frac{HFov}{2} )}{d / tan ( θ )} )$$

where even represents rounding up; Heyebox represents the horizontal length of the eyebox; and HFov represents the horizontal angle of the FOV.

In an embodiment, the right surface of the coupling-in module is in optical contact with the midpoint of the coupling-in surface of the light guide pipe 5.

The eyebox expansion array module is in optical contact with the coupling-out array module.

In an embodiment, rays transmitted from the eyebox expansion array module are coupled out of the waveguide through the coupling-out energy partial reflectors 10 with a central angle of 25.7°. The coupling-out energy partial reflectors 10 perform energy splitting at a main incident angle of 25.7°±15° and anti-reflection at an angle of 77.1°±10°, for visible light wavelengths. The distribution scheme of the coupling-out energy partial reflectors 10 is consistent with the conventional one-dimensional optical waveguide energy distribution logic and will not be further elaborated.

In an embodiment, both surfaces of the array optical waveguide are coated with anti-reflection films for visible light against air to eliminate mirror images and improve product transmittance.

The light guide pipe energy splitting system designed in this embodiment transmits rays through the light guide pipe, and reflects and overflows a portion of the energy with each oscillation, achieving the eyebox expansion. Ultimately, the eyebox expansion part only needs to be coated with one partial reflector, reducing the number of partial reflectors by over 95%.

The graded energy partial reflectors are designed in this embodiment. The reflectivity of energy partial reflector at different angles is related to the transmission times of rays. The calculation logic is provided to guide the design of the film system, providing the underlying logic basis for cost reduction.

The waveguide structure of this embodiment is compatible with various optical engine systems. If the optical machine is incident with polarized light, the light guide pipe energy partial reflector performs energy splitting on the S light using a dielectric film; if the optical machine is incident with natural light, the energy splitting is achieved using a metallic silver film, and the silver film is a thin film with a gradient thickness.

This embodiment is widely applicable to AR near-eye display fields, making low-cost mass production of two-dimensional array optical waveguides feasible.

The above is only the preferred specific embodiment of the present disclosure, but the protection scope of the present disclosure is not limited to this. Any changes or replacements that may be easily thought of by those skilled in the art within the technical scope disclosed in the present disclosure should be included in the protection scope of the present disclosure. Therefore, the protection scope of the present disclosure should be based on the protection scope of the claims.

What is claimed is:

1. A two-dimensional array optical waveguide of an eyebox expansion scheme for a light guide pipe, comprising:
a coupling-in module, an eyebox expansion array module, and a coupling-out array module;
wherein the coupling-in module, the eyebox expansion array module, and the coupling-out array module are in optical contact pairwise;
the coupling-in module and the coupling-out array module are located on left and right sides of the eyebox expansion array module, respectively;
the coupling-in module is used to introduce rays outgoing from a two-dimensional optical engine into an optical waveguide system and adjust an angle and a direction of the rays through reflection films to meet a total internal reflection condition for entering the eyebox expansion array module;
the eyebox expansion array module is used for eyebox expansion of coupled-in rays, enabling uniform distribution of the rays within the optical waveguide; and
the coupling-out array module is used to couple rays after the eyebox expansion out of the optical waveguide to obtain a target image.

2. The two-dimensional array optical waveguide of the eyebox expansion scheme for the light guide pipe according to claim 1, wherein
the coupling-in module comprises a rectangular prism with a total internal reflection film and the reflection films;
the reflection films are coated on oblique edges of the rectangular prism, and are tilted 25.7° and bonded in H-ZF1A glass; and
a working wavelength of the reflection films is visible light.

3. The two-dimensional array optical waveguide of the eyebox expansion scheme for the light guide pipe according to claim 2, wherein
the rectangular prism with the total internal reflection film comprises two right trapezoidal prisms;
an oblique edge angle of the two right trapezoidal prisms is 25.7°, and oblique edges of the two right trapezoidal prisms are bonded together;
a mechanical angle of the reflection films is 25.7°; and
an incident angle of the reflection films is 25.7°±15°.

4. The two-dimensional array optical waveguide of the eyebox expansion scheme for the light guide pipe according to claim 2, wherein
the eyebox expansion array module comprises a light guide pipe and trapezoidal prisms;
the light guide pipe is a parallelepiped, with front and rear surfaces serving as surfaces for total internal reflection and oscillation of rays with a pitch direction as a reference; and
the light guide pipe is coated with the total internal reflection film and an energy partial reflector to perform the eyebox expansion of the coupled-in rays.

5. The two-dimensional array optical waveguide of the eyebox expansion scheme for the light guide pipe according to claim 4, wherein
an upper surface of the light guide pipe is a light guide pipe energy partial reflector, and an angle between the light guide pipe energy partial reflector and the front and rear surfaces is 90°, and the light guide pipe energy partial reflector is in optical contact with an oblique surface of one of the trapezoidal prisms;
a lower surface of the light guide pipe is a light guide pipe total internal reflection film, and an angle between the light guide pipe total internal reflection film and the front and rear surfaces is 90°, the light guide pipe total internal reflection film is parallel to the light guide pipe energy partial reflector, and the light guide pipe total internal reflection film is in optical contact with an oblique surface of one of the trapezoidal prisms;
a left surface of the light guide pipe is a ray coupling-in surface, and the ray coupling-in surface forms a 90° angle with the front and rear surfaces and a 45° angle with the light guide pipe energy partial reflector and the light guide pipe total internal reflection film; and
a right surface of the light guide pipe is a ray coupling-out surface, and the ray coupling-out surface forms a 90° angle with the front and rear surfaces and a 45° angle with the light guide pipe energy partial reflector and the light guide pipe total internal reflection film.

6. The two-dimensional array optical waveguide of the eyebox expansion scheme for the light guide pipe according to claim 5, wherein
the light guide pipe total internal reflection film is incident at a visible light wavelength and an incident angle of 56.5°±15°; and
the light guide pipe energy partial reflector is incident at the visible light wavelength and the incident angle of 56.5°±15°.

7. The two-dimensional array optical waveguide of the eyebox expansion scheme for the light guide pipe according to claim 4, wherein
a tilt angle of the light guide pipe is related to required field of view, eyebox, and eye relief of a product; and
a larger the eyebox, a greater the tilt angle of the light guide pipe.

8. The two-dimensional array optical waveguide of the eyebox expansion scheme for the light guide pipe according to claim 1, wherein
the coupling-out array module comprises parallelepipeds and trapezoidal prisms;
upper and lower surfaces of the coupling-out array module are coated with anti-reflection films;
inclined surfaces of the parallelepipeds are coated with coupling-out energy partial reflectors; and
an angle between the coupling-out energy partial reflectors and the upper and lower surfaces is 25.7°, a first surface and a last surface are respectively in optical contact with one of the trapezoidal prisms, and the parallelepipeds are in optical contact pairwise.

9. The two-dimensional array optical waveguide of the eyebox expansion scheme for the light guide pipe according to claim 8, wherein
a mechanical angle of the coupling-out energy partial reflectors is 25.7°;
the mechanical angle of the coupling-out energy partial reflectors is equal to a mechanical angle of a coupling-in reflection film; and
a number of layers of the coupling-out energy partial reflectors is related to required field of view, eyebox, eye relief, and waveguide thickness, with energy increasing progressively along a ray transmission direction.

10. The two-dimensional array optical waveguide of the eyebox expansion scheme for the light guide pipe according to claim 1, wherein
both surfaces of the two-dimensional array optical waveguide are coated with anti-reflection films for visible light against air.
